(19) United States
(12) Patent Application Publication
(10) Pub. No.: US 2021/0157949 A1
(43) Pub. Date: May 27, 2021

(54) EVENT DATA TAGGED WITH CONSENT RECORDS

(71) Applicant: HEWLETT-PACKARD DEVELOPMENT COMPANY, L.P., Spring, TX (US)

(72) Inventors: John LANDRY, Spring, TX (US); Francisco BESCHOREN DA COSTA, Spring, TX (US); Charles FAHSELT, Spring, TX (US); Christopher Tomas STEWART, Spring, TX (US)

(21) Appl. No.: 16/691,276

(22) Filed: Nov. 21, 2019

(51) Int. Cl. G06F 21/62; G06F 9/54

(52) U.S. Cl. CPC G06F 21/6245; G06F 9/542

(57) ABSTRACT

In some examples, a computing device comprises a network interface; a storage device comprising machine-readable instructions; a processor coupled to the network interface and the storage device, wherein execution of the machine-readable instructions causes the processor to: collect a user consent on whether to share event data of multiple applications of the computing device; store the user consent in a consent record; collect event data from an application of the multiple applications; and tag the event data with the user consent from the consent record.

### BACKGROUND

Event data is information about the daily operations of hardware, applications, and security components of a computing device. Event data may provide useful information in analyzing the performance of the computing device and diagnosing possible causes of issues or failures on the computing device (e.g., support, cybersecurity). Event data may assist a manufacturer in the development of future products (e.g., product enhancement). Event data may also be used for recommending new products or suggesting maintenance plans (e.g., marketing). Event data may also be used for collecting information pertaining to a user (e.g., health, demographics).

### BRIEF DESCRIPTION OF THE DRAWINGS

Various examples will be described below referring to the following figures:

FIG. 1 is a schematic diagram of a computing device, in accordance with various examples;

FIG. 2 is a schematic diagram of a computing device, in accordance with various examples;

FIG. 3 is a schematic diagram of a computing device, in accordance with various examples;

FIG. 4 is a schematic diagram of a system, in accordance with various examples;

FIG. 5 is a schematic diagram of a system, in accordance with various examples;

FIG. 6 is a schematic diagram of a system, in accordance with various examples; and

FIG. 7 is a schematic diagram of a system, in accordance with various examples.

### DETAILED DESCRIPTION

As explained above, event data of a computing device (e.g., laptop, notebook, tablet, smartphone, mobile device, or some other electronic device with an ability to capture data about operations of the device) may be utilized for a number of purposes (e.g., marketing, support, product enhancement, health, demographics, cybersecurity, or any other purpose for which event data may be collected). For example, event data indicates a user has owned the computing device for a number of years. The manufacturer of the computing device, in preparation for launching a new computing device in the product line, might target the user with advertisements for the new computing device (e.g., marketing). In another example, event data may provide the manufacturer of the computing device with operational information of components (e.g., a battery) of the computing device. In some instances, the operational information might be usable to troubleshoot why a component failed (e.g., support). In other instances, the operational information might be usable in the development of a next generation of the component (e.g., product enhancement). In yet another example, event data indicates malware has been detected. In some instances, the operational information might be usable to troubleshoot why the computing device is not working properly (e.g., support). In other instances, the operational information might be usable to discover how the security of the computing device was breached (e.g., cybersecurity).

For privacy reasons, the user may want to limit the purposes for which event data of the computing device is shared. For example, the user may not want to receive marketing information or share biometric or location data, but may want support or security services and may be interested in contributing information to assist in the development of future products. In some examples, such as when the computing device is owned by an enterprise (e.g., business, company), the enterprise may want to control how event data of the computing device is shared. Additionally, government regulations may mandate that the user provide consent for the collection of data from the computing device. However, because event data is collected by multiple applications (e.g., machine-readable instructions) and pertains to the operations of numerous components (e.g., hardware; applications; security components), a user may be prompted to consent to sharing event data multiple times (e.g., for each application of the multiple applications).

This disclosure describes various examples of collecting a user consent for sharing event data of multiple applications of a computing device. The user consent indicates whether a user has given no permission, limited permission, or full permission for the sharing of event data. The user consent may be stored in a consent record accessible by the multiple applications. Event data of the multiple applications may be collected. The event data may be tagged with the user consent from the consent record. In various examples, a system may receive the tagged event data. The system may examine the user consent of the tagged event data to determine for what purposes the system may use the event data.

In one example in accordance with the present disclosure, a computing device is provided. The computing device comprises a network interface; a storage device comprising machine-readable instructions; and a processor coupled to the network interface and the storage device. Execution of the machine-readable instructions causes the processor to: collect a user consent on whether to share event data of multiple applications of the computing device; store the user consent in a consent record; collect event data from an application of the multiple applications; and tag the event data with the user consent from the consent record.

In another example in accordance with the present disclosure, a non-transitory computer-readable medium storing machine-readable instructions is provided. When executed by a processor, the machine-readable instructions cause the processor to: collect a user consent on whether to share event data of multiple applications of a computing device; store the user consent in a consent record, the consent record having an identifier; verify a security of an application of the multiple applications; collect event data from the application in response to the security of the application being verified; and tag the event data with the user consent from the consent record and with the consent record identifier.

In yet another example in accordance with the present disclosure, a system is provided. The system comprises a network interface; a storage device comprising machine-readable instructions; and a processor coupled to the network interface, the processor to access the storage device. Execution of the machine-readable instructions causes the processor to: collect event data of a computing device, the event data tagged with a user consent; and categorize the tagged event data based on the user consent.

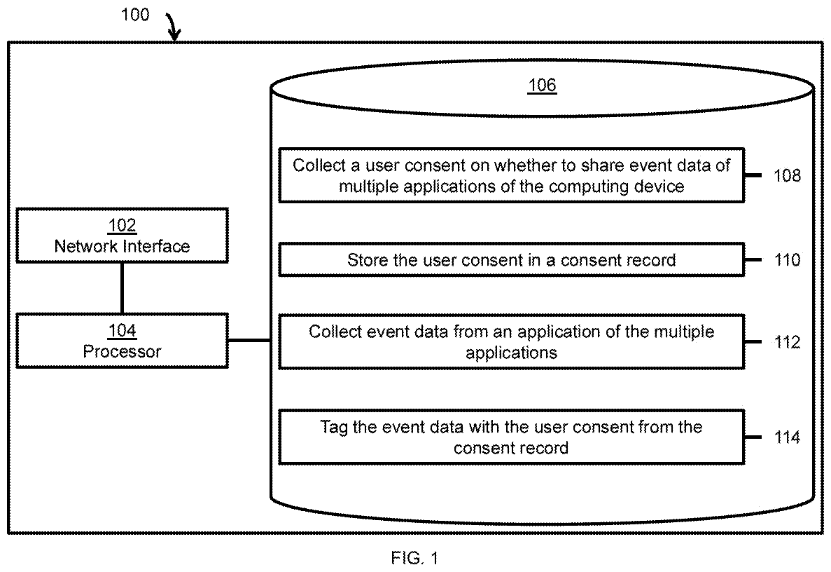

FIG. 1 is a schematic diagram of a computing device 100, in accordance with various examples. The computing device 100 comprises a network interface 102, a storage device 106, and a processor 104 coupled to the network interface 102 and the storage device 106. The computing device 100 may be a mobile device, smartphone, laptop, notebook, tablet, or some other electronic device with an ability to capture data about operations of the device, for example. The processor 104 may be a microprocessor, a microcomputer, a microcontroller, or another suitable processor or controller, for example. The storage device 106 may include a hard drive, solid state drive (SSD), flash memory, random access memory (RAM), or other suitable memory, for example. In some examples, the storage device 106 may store machine-readable instructions, which when executed, cause the processor 104 to perform some or all of the actions attributed herein to the processor 104.

In some examples, the storage device 106 may store machine-readable instructions 108, 110, 112, and 114. The instructions 108, 110, 112, 114 may be machine-readable instructions for execution by the processor 104. The machine-readable instructions 108, 110, 112, 114 may cause the processor 104 to collect a user consent and tag subsequently collected event data with the user consent. Execution of instruction 108 may cause the processor 104 to collect the user consent on whether to share event data of multiple applications of the computing device 100. Execution of instruction 110 may cause the processor 104 to store the user consent in a consent record. Execution of instruction 112 may cause the processor 104 to collect event data from an application of the multiple applications. Execution of instruction 114 may cause the processor 104 to tag the event data with the user consent from the consent record.

As disclosed above, the user consent indicates whether the user has given no permission, limited permission, or full permission for the sharing of event data of the computing device 100. The user consent applies to the computing device 100. For example, if the computing device 100 has multiple users, then any user with the appropriate administrative rights may modify the user consent. The modified user consent applies to the subsequently collected event data, regardless of which of the multiple users is logged on to the computing device 100. If the user provides no permission, then collection of event data may not occur. If the user provides full permission (e.g., permission granted for every permission option available) or limited permission (e.g., permission granted for some permission options), then collection of event data may occur. The user consent may comprise an indicator for each permission option. In some examples, if the user has given permission for the permission option, then the indicator represents “yes;” if the user has not given permission for the permission option, then the indicator represents “no.” The user consent may be stored in a consent record. In various examples, the consent record is implemented as a data structure (e.g., lookup table, database). In addition to the user consent, the consent record may contain information related to the user (e.g., a user identifier (ID)), the purposes for which the user consents, how the user consent is obtained (e.g., the out-of-box experience (OOBE), the user consent application, execution of one of the multiple applications), a date the user consent is obtained, a time the user consent is obtained, an identifier of the computing device 100, or other relevant information. The processor 104 may assign the consent record an identifier. The processor 104 may store the identifier in the consent record data structure. The consent record may be stored on the storage device 106. In some examples, such as when an enterprise owns the computing device 100, the user consent may be stored to the storage device 106 during manufacture.

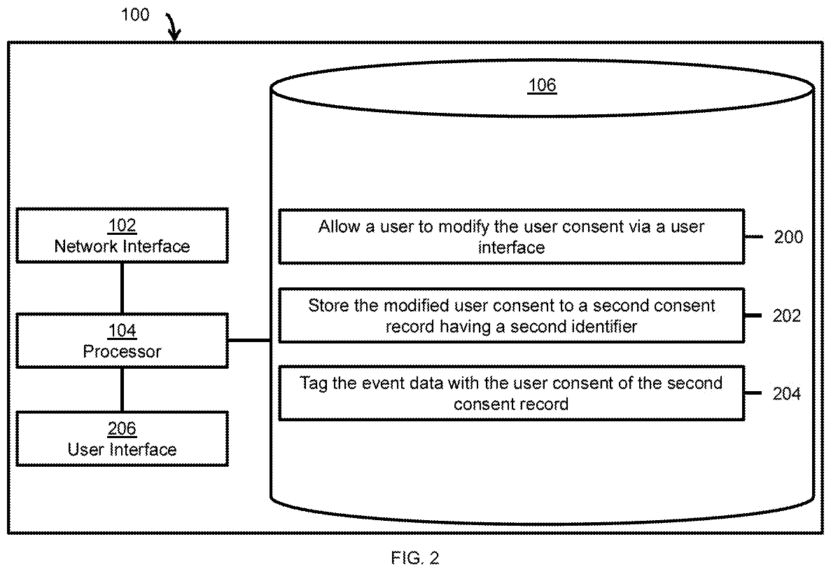

As discussed above, the consent record may be accessible by multiple applications. In some examples, access to the consent record is controlled by a centralized consent service. The centralized consent service comprises machine-readable instructions. Execution of the machine-readable instructions of the centralized consent service may cause the processor 104 to perform some or all of the actions attributed herein to the centralized consent service. The centralized consent service may receive requests to access the consent record from the multiple applications. Execution of the machine-readable instructions of the centralized consent service may cause the processor 104 to access the storage device 106 to retrieve the consent record and supply the consent record to the multiple applications. For an example, see the discussion below with respect to FIG. 2.

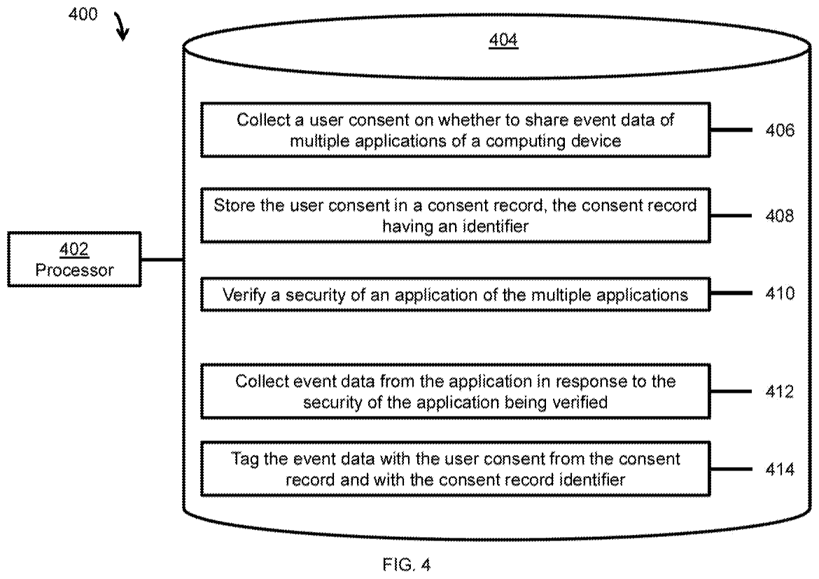

The multiple applications are machine-readable instructions. In some examples, an application of the multiple applications may be installed on the computing device 100 during manufacture. In various examples, the multiple applications share a level of trust, as discussed below with regard to FIG. 4, such that the consent record may be accessible between the multiple applications. For example, the multiple applications may be Universal Windows Platform (UWP) applications sharing consent settings provided by Hardware Supported Application (HSA) architecture. In some examples, if an application of the computing device 100 does not share a level of trust with the multiple applications, then the application may not be given access to the consent record.

As disclosed above, event data may be collected from the multiple applications by the processor 104. Event data may be collected real-time (e.g., as an application executes, as a component operates); at scheduled increments (e.g., every 15 minutes, every hour, daily); or on demand from the computing device 100. In various examples, event data is implemented as a data structure (e.g., lookup table, database). Event data may contain information related to an event (e.g., an application being utilized when the event happened; a version of the application being utilized when the event happened; an event type (e.g., error, warning, information); an event code; a description of the event). In some examples, at the time of event data collection, the processor 104 tags the event data with the user consent of the consent record. In various examples, tagging the event data with the user consent includes tagging the event data with the identifier of the consent record. In some examples, tagging adds the user consent to the data structure of the event. In other examples, tagging comprises converting the user consent to a bit mask, where each type of user consent is associated with a portion of the bit mask. The bit mask may then be added to the data structure of the event. In various examples, the centralized consent service may cause the processor 104 to collect and tag event data.

In various examples, prior to collecting the user consent on whether to share event data of multiple applications of the computing device 100, the processor 104 may examine the storage device 106 to determine if a consent record is stored. If a consent record is not stored, then the processor 104 may collect the user consent on whether to share event data of multiple applications of the computing device 100 under certain conditions. The conditions may include an OOBE (e.g., first user experience with a new computing device 100); execution of a user consent application; or execution of one of the multiple applications. Gathering the user consent under limited conditions enhances the user experience by avoiding redundant user consent requests.

FIG. 2 is a schematic diagram of the computing device 100, in accordance with various examples. As discussed above in regard to FIG. 1, the computing device 100 comprises the network interface 102, the storage device 106, and the processor 104 coupled to the network interface 102 and the storage device 106. The computing device 100 may also comprise a user interface 206 coupled to the processor 104. The user interface 206 may be an application that when executed collects the user consent for sharing of event data of the computing device 100. Execution of machine-readable instructions of the user interface 206 may cause the processor 104 to perform some or all of the actions attributed herein to the user interface 206. The user interface 206 may cause the processor 104 to provide information to a user (e.g., via a display) and allow the user to input information (e.g., via a keyboard, mouse, or touchscreen display).

In some examples, the storage device 106 may store machine-readable instructions 200, 202, and 204. The instructions 200, 202, 204 may be machine-readable instructions for execution by the processor 104. The machine-readable instructions 200, 202, 204 may cause the processor 104 to modify the user consent and tag event data with the modified consent. Execution of instruction 200 may cause the processor 104 to allow a user to modify the user consent via the user interface 206. Execution of instruction 202 may cause the processor 104 to store the modified user consent to a second consent record having a second identifier. Execution of instruction 204 may cause the processor 104 to tag the event data with the user consent from the second consent record.

As discussed above with respect to FIG. 1, the consent record may be implemented as a data structure (e.g., lookup table, database). In some examples, the consent record is a record within a data structure (e.g., lookup table, database) comprising multiple consent records. When the processor 104 obtains a modified user consent, the processor 104 may create a new consent record to add to the data structure comprising multiple consent records. The processor 104 may assign the new consent record a unique identifier.

As discussed above with respect to FIG. 1, the consent record may be accessed via a centralized consent service. Upon execution of the user interface 206, the user interface 206 may send a request to the centralized consent service to provide a current prompt for each permission option of the user consent. The centralized consent service may cause the processor 104 to retrieve a prompt stored in the storage device 106 and provide the user interface 206 with the prompt for each permission option of the user consent. For example, the text for support permission may state: “Service provider may use information about my system to provide me with customer support.” The text for product enhancement permission may state: “Service provider may use information about my system to improve service provider products and services,” for example. For example, the text for marketing permission may state: “Service provider may use my contact details and information about my system to send me personalized offers and news.”

The user interface 206 may send a request to the centralized consent service to provide a consent record. The centralized consent service may cause the processor 104 to retrieve the current consent record stored on the storage device 106 and to provide the current consent record to the user interface 206. The user interface 206 may present the current consent record via a display. For example, each prompt representing a permission may be followed by a “yes” check box and a “no” check box, or some other suitable graphic that accepts user selection between two options. The user interface 206 may present the current consent record by placing indicators in the appropriate option. The user interface 206 may allow the user to modify the consent record by placing an indicator in the alternate option. If the user selects an alternate option, then the consent record may be considered modified. The user interface 206 may send the modified consent record to the centralized consent service. The centralized consent service may cause the processor 104 to store to the storage device 106 the modified consent record as a second consent record having a second identifier. Event data collected after the modified consent record is stored may be tagged with the user consent of the second consent record. The event data may also be tagged with the second identifier.

As discussed above with respect to FIG. 1, prior to collecting the user consent on whether to share event data of multiple applications of the computing device 100, the processor 104 may examine the storage device 106 to determine if a consent record is stored. If a consent record is not stored, then the processor 104 may collect the user consent on whether to share event data of multiple applications of the computing device 100 under certain conditions to avoid redundant prompts of a user for user consent. However, even if a consent record is stored, the processor 104 may prompt a user for user consent if the centralized consent service has reset the user consent to an unknown state. For example, if the user interface 206 is uninstalled from the computing device 100, the centralized consent service resets the user consent to unknown. When one of the multiple applications attempts to access the consent record, the user may be prompted for the user consent. In another example, if the user resets the computing device 100 to a factory state (e.g., deletes anything installed to the computing device 100 after manufacture), then the centralized consent service resets the user consent to unknown. When one of the multiple applications attempts to access the consent record, the user may be prompted for the user consent.

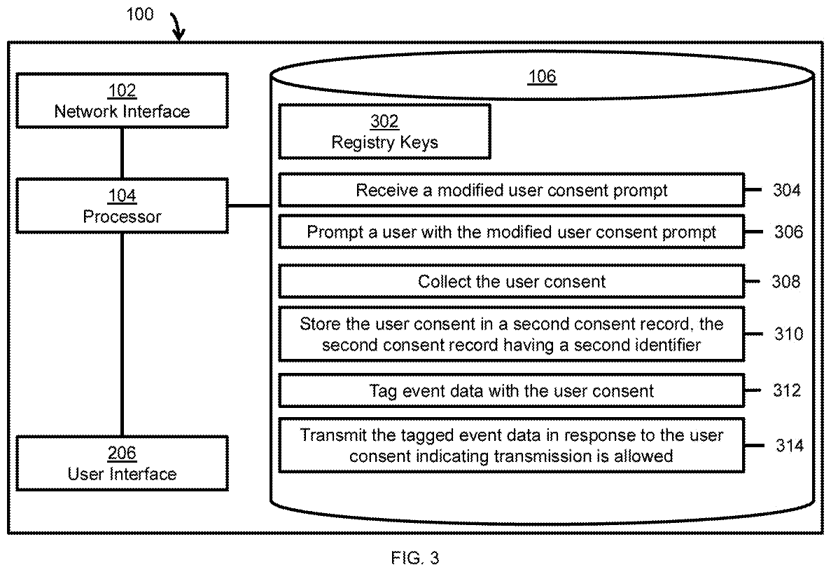

FIG. 3 is a schematic diagram of the computing device 100, in accordance with various examples. As discussed above in regard to FIG. 2, the computing device 100 comprises the network interface 102, the storage device 106, the user interface 206, and the processor 104 coupled to the network interface 102, the storage device 106, and the user interface 206. The storage device 106 may store registry keys 302 and machine-readable instructions 304, 306, 308, 310, 312, and 314. The registry keys 302 may be WINDOWS® registry keys, for example. The instructions 304, 306, 308, 310, 312, 314 may be machine-readable instructions for execution by the processor 104. The machine-readable instructions 304, 306, 308, 310, 312, 314 may cause the processor 104 to prompt a user with a modified user consent prompt, collect a modified user consent, and transmit event data tagged with the modified user consent. Execution of instruction 304 may cause the processor 104 to receive the modified user consent prompt. Execution of instruction 306 may cause the processor 104 to prompt the user with the modified user consent prompt. Execution of instruction 308 may cause the processor 104 to collect the user consent. Execution of instruction 310 may cause the processor 104 to store the user consent in a second consent record, the second consent record having a second identifier. Execution of instruction 312 may cause the processor 104 to tag event data with the user consent. Execution of instruction 314 may cause the processor 104 to transmit the tagged event data in response to the user consent indicating transmission is allowed.

In some examples, an enterprise may utilize the registry keys 302 to set the user consent of the consent record. Each permission option of the user consent may have its own registry key of the registry keys 302. In some examples, the registry keys 302 may be set during manufacture. Once set, the registry keys 302 may be updated by those with sufficient administrative privileges, as determined by the enterprise. In some examples, an update to the registry keys 302 may cause the processor 104 to collect the user consent from the registry keys 302 and store the user consent in a second consent record with a second consent record identifier.

In various examples, the computing device 100 may receive an update with a modified user consent prompt. For example, in response to a government regulatory change, the modified user consent prompt may update a permission option or options or request an additional permission option or options of the user consent. As discussed above with regard to FIG. 2, a centralized consent service may manage the prompt for each permission option of the user consent. Allowing the centralized consent service to manage the prompts simplifies the update process because the prompts are updated in the centralized consent service alone and not individually in every application that may request the user consent.

As mentioned above, upon collection, event data is tagged with information of the consent record. Event data may be collected real-time, at scheduled increments, or on demand from the computing device 100. Event data may be transmitted real-time, at scheduled increments, or on demand from the computing device 100. A user may modify user consent at any time. In some examples, event data is collected and tagged with a first consent record that allows transmission. However, the event data is not transmitted. Instead, the event data is placed in a queue for later transmission. Prior to transmission, the user modifies user consent to deny transmission. The modified user consent is stored in a second consent record. When a request for the queued event data is made to the processor 104, the processor 104 may check the most recent user consent record (e.g., second) to determine if transmission is allowed. Since the second consent record denies transmission, the tagged event data is not transmitted.

FIG. 4 is a schematic diagram of a system 400, in accordance with various examples. The system 400 comprises a computer-readable medium 404 and a processor 402 coupled to the computer-readable medium 404. The system 400 may be a computing device (e.g., the computing device 100) or a network of computing devices (e.g., local area network (LAN), wide area network (WAN), virtual private network (VPN), client/server network, Internet (e.g., cloud), or any other suitable system for sharing processing and memory resources). The computer-readable medium 404 may be a storage device such as a hard drive, solid state drive (SSD), flash memory, random access memory (RAM), or other suitable memory, for example. The computer-readable medium 404 may be local to the computing device (e.g., storage device 106) or may be on a remotely managed storage device (e.g., enterprise cloud, public cloud, data center, server, or some other suitable storage device). The processor 402 may be a microprocessor, a microcomputer, a microcontroller, or another suitable embedded processor or embedded controller, for example. The processor 402 may be local to the computing device comprising the computer-readable medium 404 (e.g., processor 104) or may be on a remotely managed computing device (e.g., server, central server, edge server, or some other suitable computing device). The computer-readable medium 404 may store machine-readable instructions, which, when executed, cause the processor 402 to perform some or all of the actions attributed herein to the processor 402.

The computer-readable medium 404 comprises machine-readable instructions 406, 408, 410, 412, 414. The instructions 406, 408, 410, 412, 414 may be machine-readable instructions for execution by the processor 402. Execution of the machine-readable instructions 406, 408, 410, 412, 414 may cause the processor 402 to verify a security of an application before tagging the event data with the user consent. Execution of instruction 406 may cause the processor 402 to collect a user consent on whether to share event data of multiple applications of a computing device. Execution of instruction 408 may cause the processor 402 to store the user consent in a consent record, the consent record having an identifier. Execution of instruction 410 may cause the processor 402 to verify a security of an application of the multiple applications. Execution of instruction 412 may cause the processor 402 to collect event data from the application in response to the security of the application being verified. Execution of instruction 414 may cause the processor 402 to tag the event data with the user consent from the consent record and with the consent record identifier.

In various examples, to verify a security of an application of the multiple applications, a shared library service is utilized. The shared library service is comprised of machine-readable instructions. Execution of the machine-readable instructions of the shared library service may cause the processor 402 to perform some or all of the actions attributed herein to the shared library service. As discussed above, the consent record may be accessible by multiple applications and access to the consent record may be controlled by a centralized consent service. The multiple applications may utilize the shared library service to request access to the consent record from the centralized consent service. In some examples, the centralized consent service, the shared library service, and the multiple applications each comprise a digital security certificate. When an application of the multiple applications attempts to access the consent record utilizing the shared library service, the shared library service may verify a signature of the centralized consent service using the corresponding digital security certificate. In response to the verification, the shared library service may initiate communications with the centralized consent service. The centralized consent service may verify the signature of the shared library service using the corresponding digital security certificate and the signature of the application using the corresponding digital security certificate (e.g., machine-readable instruction 410). In response to the verification for both the shared library service and the application, the centralized consent service may respond to the communication attempt of the shared library service. In some examples, the communication attempt of the shared library service is a request to send event data of the application to the centralized consent service. The centralized consent service may collect the event data of the application (e.g., machine-readable instruction 412). The centralized consent service may tag the event data with the user consent from the consent record and with the consent record identifier (e.g., machine-readable instruction 414).

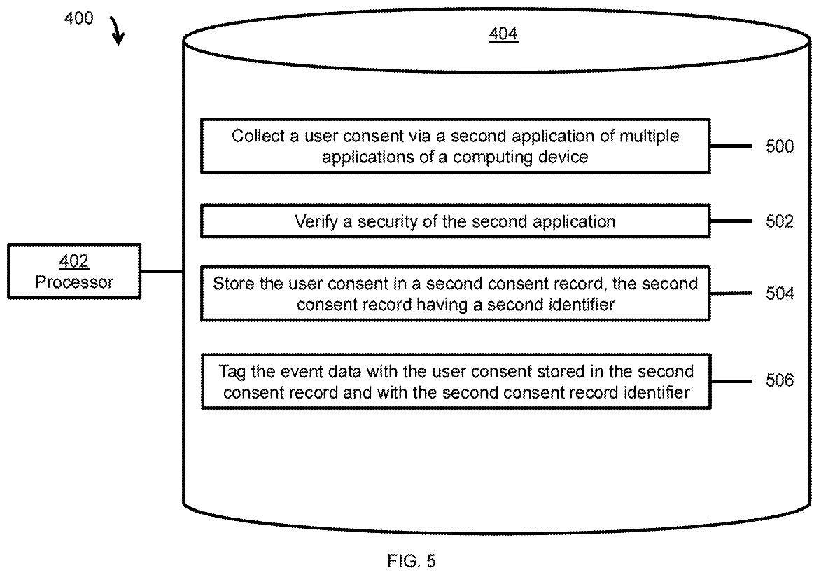

FIG. 5 is a schematic diagram of the system 400, in accordance with various examples. As discussed above in regard to FIG. 4, the system 400 comprises the computer-readable medium 404 and the processor 402 coupled to the computer-readable medium 404. The computer-readable medium 404 may comprise machine-readable instructions 500, 502, 504, 506 for execution by the processor 402. Execution of the machine-readable instructions 500, 502, 504, 506 may cause the processor 402 to collect a user consent via a second application of the multiple applications and verify a security of a second application before tagging event data. Execution of instruction 500 may cause the processor 402 to collect a user consent via a second application of multiple applications of a computing device (e.g. 100). Execution of instruction 502 may cause the processor 402 to verify a security of the second application. Execution of instruction 504 may cause the processor 402 to store the user consent in a second consent record, the second consent record having a second identifier. Execution of instruction 506 may cause the processor 402 to tag the event data with the user consent stored in the second consent record and with the second consent record identifier.

As discussed above with respect to FIG. 1 and FIG. 2, prior to collecting the user consent on whether to share event data of multiple applications of the computing device 100, the processor 104 may examine the storage device 106 to determine if a consent record is stored. If a consent record is not stored, then the processor 104 may collect the user consent on whether to share event data of multiple applications of the computing device 100 under certain conditions to avoid redundant prompts of a user for user consent. However, even if a consent record is stored, the processor 104 may prompt a user for user consent if the centralized consent service has reset the user consent to an unknown state. In some examples, the processor 104 checks for the state of the user consent and prompts the user for user consent utilizing a user consent application. The user consent application is an application of the multiple applications. In other examples, the processor 104 discovers the unknown state when a second application of the multiple applications attempts to execute. The processor 104 may collect the user consent via the second application (e.g., 500).

As discussed above with respect to FIG. 4, the multiple applications may utilize the shared library service to request access to the consent record from the centralized consent service. In some examples, the security of the second application is verified after collecting the user consent via the second application (e.g., machine-readable instruction 502). When the second application requests that the centralized consent service store the user consent to a new consent record, the shared library service may verify the signature of the centralized consent service using the corresponding digital security certificate. In response to the verification, the shared library service may initiate communications with the centralized consent service. The centralized consent service may verify the signature of the shared library service utilizing the corresponding digital security certificate and the signature of the second application utilizing the corresponding digital security certificate. In response to the verification for both the shared library service and the second application, the centralized consent service may respond to the request to store the user consent. The centralized consent service may collect the user consent from the second application. The centralized consent service may create a second consent record having a second identifier and store the user consent in the second consent record (e.g., machine-readable instruction 504). The centralized consent service may tag subsequently collected event data with the user consent from the second consent record and with the second consent record identifier (e.g., machine-readable instruction 506).

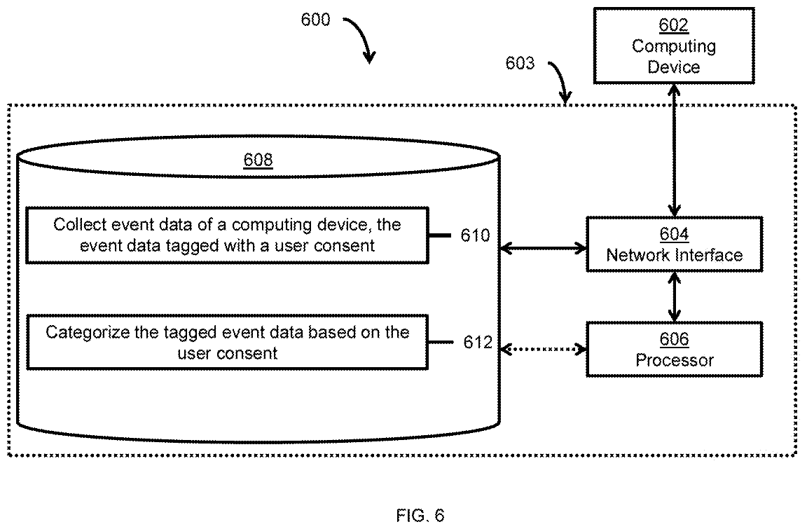

FIG. 6 is a schematic diagram of a system 600, in accordance with various examples. The system 600 comprises a computing device 602 and a processing environment 603. The processing environment 603 comprises a network interface 604, a processor 606, and a storage device 608. The processing environment 603 may be a network of computing devices (e.g., local area network (LAN), wide area network (WAN), virtual private network (VPN), client/server network, Internet (e.g., cloud)) or any other suitable system for sharing processing and memory resources. In some examples, the processor 606 may be coupled to the network interface 604 and the storage device 608 on a computing device. In other examples, the processor 606 may be a remotely managed online computing device separate from, but communicatively coupled to the storage device 608 via the network interface 604. The processor 606 may comprise a microprocessor, a microcomputer, a microcontroller, or some other suitable processor or controller. The computing device 602 may be a laptop, notebook, tablet, smartphone, mobile device, or some other electronic device with an ability to capture data about operations of the device. The computing device 602 may be remote to, but communicatively coupled to the storage device 608 via the network interface 604. The storage device 608 may comprise a hard drive, a solid state drive (SSD), flash memory, random-access memory (RAM), or some other suitable storage device. The storage device 608 may be a remotely managed, online, centralized storage device such as an enterprise cloud, a public cloud, a data center, a server, a database, or some other suitable storage device. The storage device 608 may include machine-readable instructions, which, when executed, cause the processor 606 to perform some or all of the actions attributed herein to the processor 606.

In some examples, the storage device 608 may store machine-readable instructions 610, 612. Execution of the machine-readable instructions 610, 612 may cause the processor 606 to collect event data of the computing device 602 and categorize the event data. Execution of the machine-readable instruction 610 may cause the processor 606 to collect event data of a computing device 602, the event data tagged with a user consent. Execution of the machine-readable instruction 612 may cause the processor 606 to categorize the tagged event data based on the user consent.

In various examples, the system 600 may categorize the tagged event data by the permission option of the user consent. For example, event data tagged with a marketing permission option enabled may be aggregated; event data tagged with a support permission option enabled may be aggregated; event data tagged with a product enhancement permission option may be aggregated; event data tagged with a health permission option may be aggregated; event data tagged with a demographics permission option may be aggregated; and event data tagged with a cybersecurity permission option may be aggregated. In other examples, event data from multiple computing devices communicatively coupled via the network interface 604 may be aggregated together by an enabled permission option of the user consent.

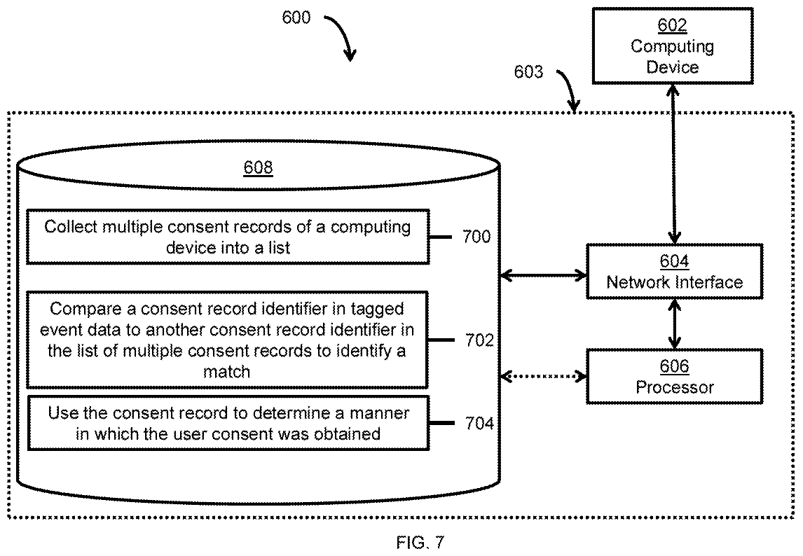

FIG. 7 is a schematic diagram of the system 600, in accordance with various examples. As discussed above in regard to FIG. 6, the system 600 comprises the computing device 602 and the processing environment 603. The processing environment 603 comprises a network interface 604, a processor 606, and a storage device 608. The processing environment 603 may be a network of computing devices (e.g., local area network (LAN), wide area network (WAN), virtual private network (VPN), client/server network, Internet (e.g., cloud)) or any other suitable system for sharing processing and memory resources. The storage device 608 may include machine-readable instructions 700, 702, 704 for execution by the processor 606. Execution of the machine-readable instructions 700, 702, 704 may cause the processor 606 to compare the consent record identifier of tagged event data with identifiers in a list of multiple consent records of a computing device 602 to determine how the user consent was obtained. Execution of the machine-readable instruction 700 may cause the processor 606 to collect multiple consent records of the computing device 602 into a list. Execution of the machine-readable instruction 702 may cause the processor 606 to compare a consent record identifier in tagged event data to another consent record identifier in the list of multiple consent records to identify a match. Execution of the machine-readable instruction 704 may cause the processor 606 to use the consent record to determine a manner in which the user consent was obtained.

In various examples, after matching the consent record identifier to a consent record identifier in the list of multiple consent records, the system 600 may determine if the user consent of tagged event data matches the user consent of the matched consent record. In some examples, if the user consent of the event data does not match the user consent in the matched consent record, then the system 600 does not use the event data for any purpose. In other examples, the system 600 may use the event data for the permission options of the user consent in the tagged event data that match the permission options in the matched consent record.

In various examples, the system 600 may utilize the matched consent record to generate reports, notifications, or perform support services. In some examples, the reports may comprise information on how user consents are obtained. In other examples, the reports may comprise information on the permission options for which a user consents.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the above discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

What is claimed is:

1. A computing device, comprising:
a network interface;
a storage device comprising machine-readable instructions;
a processor coupled to the network interface and the storage device, wherein execution of the machine-readable instructions causes the processor to:
collect a user consent on whether to share event data of multiple applications of the computing device;
store the user consent in a consent record;
collect event data from an application of the multiple applications; and
tag the event data with the user consent from the consent record.

2. The computing device of claim 1, wherein execution of the machine-readable instructions causes the processor to tag the event data with an identifier of the consent record.

3. The computing device of claim 1, wherein execution of the machine-readable instructions causes the processor to:
allow a user to modify the user consent via a user interface; and
store the modified user consent to a second consent record having a second identifier.

4. The computing device of claim 3, wherein execution of the machine-readable instructions causes the processor to tag the event data with the user consent of the second consent record.

5. The computing device of claim 1, wherein execution of the machine-readable instructions causes the processor to collect the user consent from registry keys of the computing device.

6. The computing device of claim 1, wherein execution of the machine-readable instructions causes the processor to transmit the tagged event data in response to the user consent of the consent record indicating transmission is allowed.

7. A non-transitory computer-readable medium storing machine-readable instructions which, when executed by a processor, cause the processor to:
collect a user consent on whether to share event data of multiple applications of a computing device;
store the user consent in a consent record, the consent record having an identifier;
verify a security of an application of the multiple applications;
collect event data from the application in response to the security of the application being verified; and
tag the event data with the user consent from the consent record and with the consent record identifier.

8. The computer-readable medium of claim 7, wherein execution of the machine-readable instructions causes the processor to collect the user consent via a second application of the multiple applications of the computing device.

9. The computer-readable medium of claim 8, wherein execution of the machine-readable instructions causes the processor to:
verify a security of the second application; and
store the user consent in a second consent record, the second consent record having a second identifier.

10. The computer-readable medium of claim 9, wherein execution of the machine-readable instructions causes the processor to tag the event data with the user consent stored in the second consent record and with the second consent record identifier.

11. The computer-readable storage of claim 7, wherein execution of the machine-readable instructions causes the processor to:
receive a modified user consent prompt;
prompt a user with the modified user consent prompt;
collect the user consent; and
store the user consent in a second consent record, the second consent record having a second identifier.

12. A system comprising:
a network interface;
a storage device comprising machine-readable instructions; and
a processor coupled to the network interface, the processor to access the storage device, wherein execution of the machine-readable instructions causes the processor to:
collect event data of a computing device, the event data tagged with a user consent; and
categorize the tagged event data based on the user consent.

13. The system of claim 12, wherein execution of the machine-readable instructions causes the processor to collect multiple consent records of the computing device into a list.

14. The system of claim 13, wherein execution of the machine-readable instructions causes the processor to compare a consent record identifier in the tagged event data to another consent record identifier in the list of multiple consent records to identify a match.

15. The system of claim 12, wherein execution of the machine-readable instructions causes the processor to use the consent record to determine a manner in which the user consent was obtained.
